(19) United States
(12) Patent Application Publication
(10) Pub. No.: US 2002/0021673 A1
(43) Pub. Date: Feb. 21, 2002

(54) Method of taking account of traffic processing capacity, for traffic load control in a mobile radio network

(75) Inventors: Pascal Agin, Sucy En Brie (FR); Patrick Blanc, Issy Les Moulineaux (FR); Olivier Visbecq, Le Chesnay (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/924,719

(22) Filed: Aug. 9, 2001

(30) Foreign Application Priority Data
Aug. 10, 2000 (FR) 00 10 538

(51) Int. Cl. H04L 12/26; H04B 7/216

(52) U.S. Cl. 370/252; 370/335

(57) ABSTRACT

A method of taking account of traffic processing capacity for the purpose of traffic load control in a mobile radio network, wherein account is taken of one or more limits in said processing capacity corresponding to one or more parameters representative of said traffic load.

The present invention relates in general to mobile radio systems, and more particularly to systems using code division multiple access (CDMA).

### BACKGROUND OF THE INVENTION

The CDMA technique is used in particular in so-called “third generation” systems, such as the universal mobile telecommunications system (UMTS).

In general, as summarized in FIG. 1, a mobile radio network comprises a set of base stations known as “Node Bs” in UMTS, and base station controllers, also known as radio network controllers (RNCs) in UMTS. In UMTS, the network is also known as the UMTS terrestrial radio access network (UTRAN). A Node B is in communication both with mobile stations (also referred to in UMTS as “user equipment” (UE)) situated within its own coverage zone or “cell”, and also to its controlling radio network controller (CRNC). The radio interface between the UE and a Node B is referred to in UMTS as the Uu interface. The interface between a Node B and an RNS is also referred to in UMTS as an Iub interface. The network is also in communication by conventional means that are not shown specifically with the usual external networks.

In CDMA systems, the capacity limitations on the radio interface are fundamentally different from those which apply to systems using other multiple access techniques, and in particular the time division multiple access (TDMA) technique. The TDMA technique is used in particular in so-called “second generation” systems such as the global system for mobile communications (GSM). In CDMA systems, all of the users share the same frequency resource at all times. Capacity in such systems is therefore limited by interference, with such systems also being referred to for this reason as soft-limited systems.

That is why, in CDMA systems, algorithms such as load control algorithms are provided for predicting overloading, for detecting overloading, and where appropriate for correcting it in order to avoid deterioration in quality, and call admission control algorithms are provided for deciding whether the capacity that is unused at a given instant within a cell is sufficient for accepting a new call in that cell (as a function of various parameters such as the service required for the call, . . . , etc.). In the text below, these various algorithms are lumped together under the general term of “load control”.

As a general rule, these algorithms make use only of radio criteria, and they are normally implemented in the CRNC which does not have information about the processing capacity of a Node B. Under such conditions, it can happen that a new call is accepted by the CRNC only to be rejected subsequently because of insufficient processing resources in the Node B, which gives rise pointlessly to additional processing in the CRNC and to additional signaling being interchanged between the CRNC and the Node B.

Naturally, it is possible to avoid those drawbacks by providing sufficient processing resources in base stations to cover all circumstances, including cases of maximum capacity (corresponding to the case where the level of interference is very low). However that leads to base stations that are expensive and overdimensioned for most of the time. In addition, in the context of introducing the services on offer in such systems progressively, the processing capacity of base stations can be limited when these systems are initially put into service and can then be increased progressively thereafter.

It would therefore be desirable to be able to take account of the traffic processing capacity of base stations (or Node Bs) for traffic load control in such a system.

For the UMTS system, document 3G TS 25.433 V3.0.0 (2000-01) published by the 3rd Generation Partnership Project (3GPP) as modified by 3GPP R3-0000520 contribution proposes that the Node B signals its overall processing capacity (referred to as its “capacity credit”) to the CRNC, together with the quantity of this processing capacity which is consumed by allocating a physical channel or spreading code for each value of the spreading factor.

As has been observed by the Applicant, and as explained in greater detail below, that solution is unsuitable for taking account of limitations in the processing capacity of a Node B. A particular object of the present invention is to avoid those drawbacks.

### OBJECTS AND SUMMARY OF THE INVENTION

The present invention thus provides a method of taking account of traffic processing capacity for the purpose of traffic load control in a mobile radio network, wherein account is taken of one or more limits in said processing capacity corresponding to one or more parameters representative of said traffic load.

According to another characteristic, one of said parameters is associated with the number of radio links that can be established, and a corresponding limit is represented by a maximum number of radio links that can be established.

According to another characteristic, said maximum number of radio links is a maximum number of radio links that can be established in macrodiversity.

According to another characteristic, said maximum number of radio links is a maximum number of radio links that can be established in transmission diversity.

According to another characteristic, said maximum number of radio links is represented by a maximum number of radio resources that can be allocated.

According to another characteristic, one of said parameters is associated with data rate for established radio links, and a corresponding limit is represented by a maximum data rate for the established radio links.

According to another characteristic, said maximum data rate is a maximum data rate in the up direction.

According to another characteristic, said maximum data rate is a maximum data rate in the down direction.

According to another characteristic, said maximum data rate is a maximum data rate for a first type of traffic, for which a first type of error correcting code is used.

According to another characteristic, said maximum data rate is a maximum data rate for a second type of traffic, for which a second type of error correcting code is used.

According to another characteristic, a first type of error correcting code is a turbo-code.

According to another characteristic, a second type of error correcting code is a convolutional code.

According to another characteristic, said data rate is a net data rate.

According to another characteristic, said limits are considered on a per cell or a per base station basis.

According to another characteristic, said limits are considered per physical channel.

According to another characteristic, said limits are considered per type of physical channel.

According to another characteristic, one type of physical channel is a dedicated physical channel.

According to another characteristic, one type of physical channel is a common physical channel.

The present invention also provides a mobile radio network, the network essentially including means for implementing such a method.

The present invention also provides a base station for a mobile radio network, said base station essentially including means for implementing such a method.

According to another characteristic, said means in said base station comprise means for signaling one or more limits in its processing capacity to a controlling base station controller, said limits corresponding to one or more parameters representative of traffic load.

The present invention also provides a base station controller for a mobile radio network, the base station controller essentially including means for implementing such a method.

According to another characteristic, said means in said base station controller include means for verifying whether one or more limits in the processing capacity of a base station it controls and corresponding to one or more parameters representative of traffic load has been reached.

### BRIEF DESCRIPTION OF THE DRAWINGS

Other objects and characteristics of the present invention will appear on reading the following description of embodiments, given with reference to the accompanying drawings, in which:

FIG. 1 summarizes the general architecture of a mobile radio system, such as the UMTS system in particular;

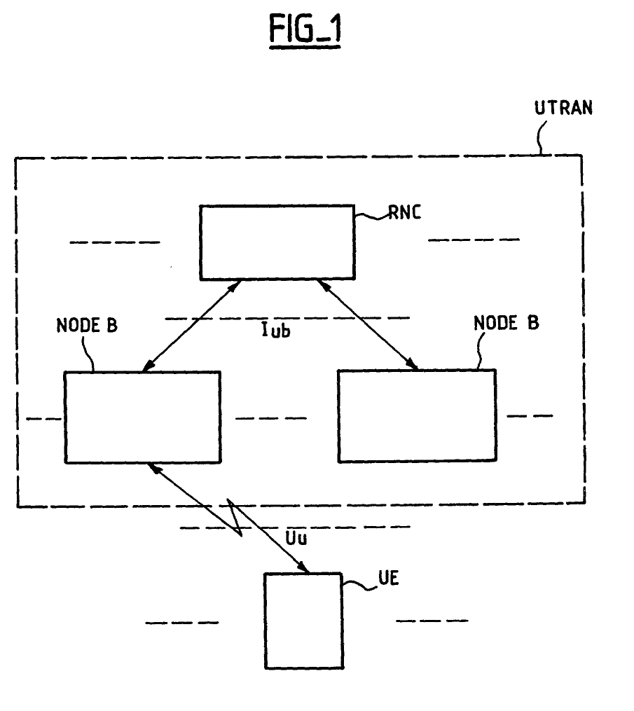

FIGS. 2 and 3 summarize the main processing used respectively in transmission and in reception in a base station such as a Node B for the UTMS system; and

FIG. 4 is a detailed diagram for illustrating an example of the method of the present invention.

### MORE DETAILED DESCRIPTION

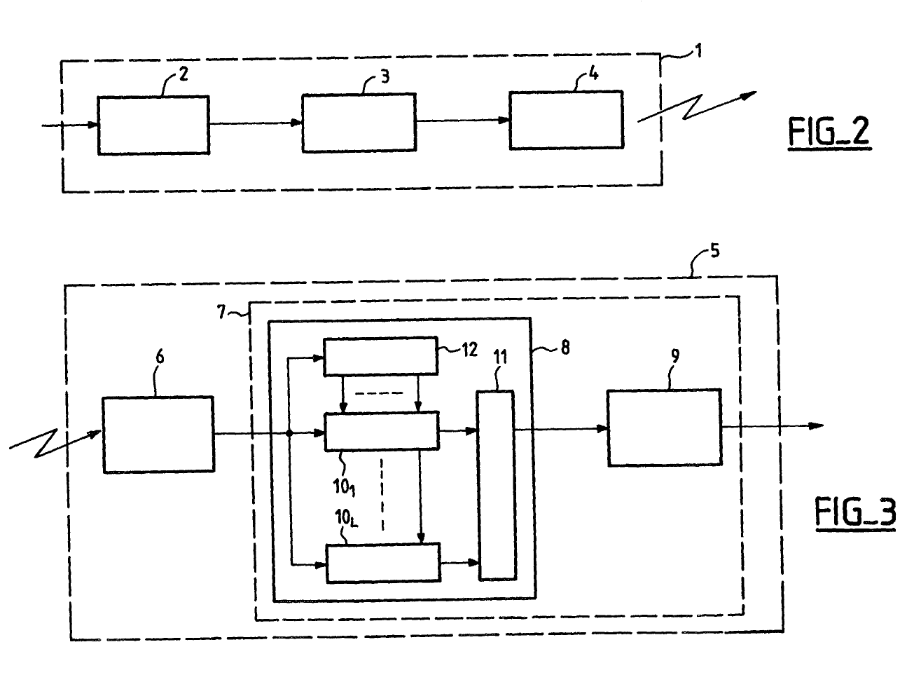

FIGS. 2 and 3 summarize the main processing used respectively in transmission and in reception in a base station, in particular such as a Node B for the UMTS system.

FIG. 2 shows a transmitter 1 comprising:

channel encoding means 2;

spreading means 3; and

radio transmitter means 4.

These various kinds of processing are well known to the person skilled in the art and do not need to be described again herein in detail.

In conventional manner, channel encoding uses techniques such as error correcting codes and interleaving for obtaining protection against transmission errors.

The encoding (such as that performed by error correcting codes) is intended to introduce redundancy into the transmitted information. The coding ratio is defined as the ratio of the number of information bits to be transmitted over the number of transmitted bits or code bits. Various levels of quality of service can be obtained by using different types of error correcting code. For example, in UMTS, for a first type of traffic (such as data traffic at a high data rate), a first type of error correcting code is used constituted by a turbo-code, and for a second type of traffic (such as voice or data at a lower data rate) a second type of error correcting code is used, constituted by a convolutional code.

Channel encoding also generally includes adapting the data rate so as to match the data rate that is to be transmitted with the data rate available for transmission. Data rate matching can include techniques such as repetition and/or puncturing, the data rate adaptation ratio then being defined as the repetition ratio and/or the puncturing ratio.

The raw data rate is defined as the data rate actually transmitted over the radio interface. The net data rate is the data rate obtained after removing from the raw data rate everything which is of no use to the user, in particular such as the redundancy introduced by the encoding.

Spreading makes use of the known principles of spectrum spreading. The length of the spreading code used is also known as the spreading factor. In systems such as the UMTS system in particular, the spreading factor can vary as a function of the data rate to be transmitted.

FIG. 3 shows a receiver 5 comprising:

radio receiver means 6; and

means 7 for estimating received data, said means themselves comprising in particular unspreading means 8 and channel decoding means 9.

These various kinds of processing are likewise well known to the person skilled in the art and therefore do not need to be described again herein in detail.

FIG. 3 shows one example of the processing that can be implemented in the unspreading means 8. In this case, this processing corresponds to that which is implemented in a Rake type receiver, serving to improve the quality of the estimate of received data, by taking advantage of multipath phenomena, i.e. propagation of a single source signal over multiple paths, as obtained in particular by multiple reflections on elements in the environment. In CDMA systems, and in particular unlike TDMA systems, advantage can be taken of these multiple paths in order to improve the quality with which received data is estimated.

A Rake receiver comprises a set of L fingers referenced 10₁ to 10_{L}, together with means 11 for combining these signals from the various fingers. Each finger serves to unspread the signal as received over one of the various paths taken into consideration, the paths to be taken into consideration being determined by the means 12 for estimating the impulse response of the transmission channel. The means 11 serve to combine the unspread signals that correspond to the various paths taken into consideration, using processing for optimizing the quality with which the received data is estimated, and then repeated many times.

The technique of reception by means of a Rake receiver is also used in connection with the macrodiversity transmission technique in which a single source signal is transmitted simultaneously to a single mobile station from a plurality of base stations. The macrodiversity transmission technique makes it possible not only to improve performance on reception, by using a Rake receiver, but also to minimize the risk of a call being lost during a handover between cells. That is why it is also referred to as a “soft” handover as opposed to the “hard” handover technique in which a mobile station is connected to only one base station at any one instant.

The means for estimating received data can also make use of various techniques for reducing interference, such as the multiuser detection technique, for example.

It is also possible to use a plurality of receive antennas. The means for estimating received data then further comprise means for combining signals obtained via the various receive antennas, likewise for the purpose of optimizing the quality with which received data is estimated.

Channel decoding includes functions such as deinterleaving and decoding with error correction. Decoding with error correction is generally significantly more complex than encoding using an error correcting code, and it can make use of techniques such as decoding by maximum likelihood, for example. With convolutional codes, it is possible to use an algorithm known as the Viterbi algorithm, for example.

To be able to process a plurality of users simultaneously, a base station or Node B has a set of transmitters and receivers such as the transmitter and the receiver outlined above. A large amount of processing capacity is thus required in a base station or Node B, in particular in reception, for the purpose of estimating received data.

Specifically, large processing capacity is required for the processing performed by the Rake receiver. At least one Rake receiver finger is necessary per active user, however the number of fingers can depend on numerous parameters such as the number of receive antennas, the number of sectors of the base station, . . . , etc. The total number of fingers of the Rake receiver generally implies a limit on the maximum number of radio links which can be established in the base station, or indeed the number of active users in the cell under consideration that can be processed simultaneously in the base station.

Large processing capacity is also required in the base station for channel decoding, mainly for decoding with error correction. In general, the quantity of processing resources required for decoding with error correction is associated with the data rate and it increases with data rate.

As mentioned in the introduction, the processing capacity of a Node B can thus be limited, in which case it is desirable for the CRNC to be able to take account thereof in algorithms such as the load control algorithm or the call admission algorithm.

The prior art solution mentioned above does not enable this requirement to be satisfied in optimum manner, in particular for the following reasons:

The processing performed in channel decoding depends on net data rate rather than raw data rate, or indeed spreading factor. For example, for a spreading factor of 128 (and thus a raw data rate of 30 kilobits per second (kbps)), the net data rate can have various values depending on the coding ratio and the data rate matching ratio, and the net data rate can typically lie in the range 5 kbps to 15 kbps. Consequently, for a fixed spreading factor, the quantity of processing in the Node B can vary significantly (for example by a factor of more than 3). Unfortunately, no account is taken of this in the prior solution.

The number of Rake receiver fingers required for estimating the transmission channel and its data depends strongly on the number of radio links. In the prior solution, the maximum number of Rake receiver fingers in the Node B cannot be taken into account in algorithms such as the load control algorithm or the call admission algorithm since this type of limit is not associated with the spreading factor.

The processing capacity signaled by the Node B to the CRNC is overall processing capacity and cannot take account of different possible limits on the processing capacity of the Node B.

According to a present invention, account is taken of one or more limits in said processing capacity, corresponding to one or more parameters representative of traffic load.

A first parameter representative of traffic load is the number of radio links that can be established, and a corresponding limit in the processing capacity of a Node B can be represented by a maximum number of radio links that can be established.

One possibility is to take account of the maximum number of radio links that can be established in macrodiversity.

As a counterpart for the improvement in the reception performance it provides, the macrodiversity transmission technique suffers from the drawback of leading more quickly to a risk of processing overload because processing resources are used to improve the quality of current calls instead of for admitting new calls, for example. That is why the maximum number of radio links that can be established in macrodiversity in the cell in question can be used to represent this type of limit in the processing capacity of a Node B, in preference to the maximum number of radio links (whether or not they are established in macrodiversity).

For similar reasons, another possibility is to take account of the maximum number of radio links that can be established in transmission diversity.

Another possibility for taking account of the maximum number of radio links that can be established is to take account of the maximum number of radio resources, or spreading codes, that can be allocated in the cell in question.

Another parameter representative of traffic load is the data rate for the radio links that are already established, and a corresponding limit in the processing capacity of a Node B could be represented by a maximum data rate for established radio links.

Preferably, the data rate taken into consideration is a net data rate.

In addition, to cover all possibilities for defining data rate in such systems, the data rate can be a bit rate, a symbol rate, or a chip rate.

The distinction between bit rate and symbol rate is usually made in systems that make use of a plurality of possible kinds of modulation. Modulation is the processing which transforms the information to be transmitted into an analog signal capable of carrying said information. Various modulation techniques are known and they are characterized by their spectrum efficiency, i.e. their ability to transmit a greater or smaller number of bits per symbol, with transmitted bit rate increasing with modulation efficiency, for given allocated frequency band.

The term chip rate is used to designate the data rate after spreading (where the term “chip” conventionally designates the unit transmission period of the signal obtained after spreading).

To take account of limits in the processing capacity of a Node B in reception, the maximum data rate taken into consideration could be a maximum data rate in the up direction.

Processing in transmission generally requires processing capacity that is less than that required for processing in reception. However, constraints on maximum data rate in transmission could also apply, particularly due to the processing by means of error correcting codes.

To take account also of limits in processing capacity in a Node B in transmission, a distinction can be drawn between:

a maximum data rate in the up direction; and

a maximum data rate in the down direction.

In addition, the quantity of processing resources necessary depends on the type of error correcting code used, for example in UMTS, a turbo-code or a convolutional code. Greater processing capacity is required for turbo-code.

The constraints on maximum data rate could then draw a distinction between:

a maximum data rate for a first type of traffic using a first type of error correcting code, such as a turbo-code in particular; and

a maximum data rate for a second type of traffic using a second type of error correcting code, such as a convolutional code, in particular.

Constraints can also be due to the memory volume available in the base station. The memory volume required depends on the data rate and on the length of the sequences on which the error correcting code and the interleaving are performed. In the UMTS system, this length is also referred to as the transmission time interval (TTI).

Thus, another limit in the processing capacity of a Node B can be represented by the memory volume available in the Node B. This type of limit can also be represented by parameters representative of traffic load, such as data rate, in particular.

The various limits taken into account can be considered on a per cell basis or on a per Node B basis, given that a single Node B can handle a plurality of cells. For a Node B handling a variety of cells, it is possible in association with each limit taken into account, to consider a per cell value and a value for the Node B.

The various limits taken into account can be signaled by the Node B to the CRNC. Under such circumstances, in order to minimize the quantity of transmission resource required for such signaling, it is possible, for example, to restrict the signaling to certain kinds of information, such as the following for example:

the maximum number of radio links that can be established in the cell or in the Node B;

the maximum net data rate in the up direction (in kbps) that the convolutional decoder of the Node B is capable of processing, taking into consideration all of the radio links established in the cell or in the Node B; and

the maximum net data rate in the up direction (in kbps) that the turbo-decoder of the Node B is capable of processing, taking into consideration all of the radio links established in the cell or in the Node B.

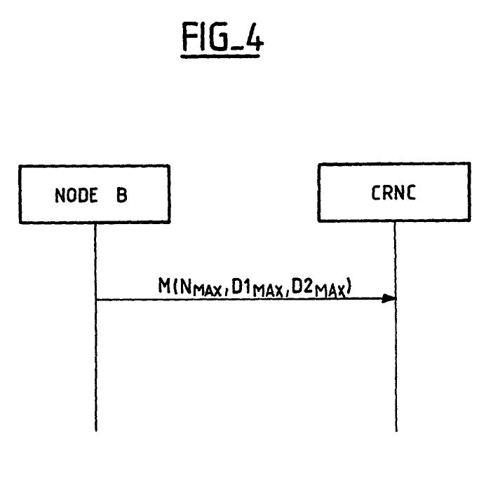

This is shown in FIG. 4 where reference M represents a signaling message sent from the Node B to the CRNC, said signaling message including the following pieces of information: maximum number of radio links (M_{MAX}); maximum data rate for convolutional decoder (D1_{MAX}); and maximum data rate for the turbo-decoder (D2_{MAX}).

For a Node B handling a plurality of cells, e.g. three cells, the signaling message sent from the Node B to the CRNC can contain, for each criterion, e.g. D1_{MAX}, four different values: one D1_{MAX} value per cell plus a D1_{MAX} value for the Node B. However, it would also be possible to send only a single D1_{MAX} value per Node B without distinguishing between the various cells.

In addition, for each of these limits, it is possible to signal a value for each physical channel. In UMTS, for example, the various physical channels include in particular the following channels:

dedicated physical data channel/dedicated physical channel control channel (DPDCH/DPCCH);

physical random access channel (PRACH);

physical downlink shared channel (PDSCH);

etc.

Instead of signaling a value per physical channel, it is also possible to signal a value for each type of physical channel. For example, one type of physical channel can be constituted by a dedicated channel (or allocated to a particular user), for example the DPDCH/DPCCH channels in UMTS, and another type of channel can be constituted by a common channel (or shared by a plurality of users), such as a PRACH in UMTS.

These limits thus make it possible in particular to take separate account of constraints on data rate due to channel decoding, and constraints on the number of radio links due to processing by means of a Rake receiver.

They can be signaled by the Node B to the CRNC each time they change, as explained in the introduction. They can be sent in a special signaling message such as the resource status indication message defined in document 3G TS 25.433 V3.0.0 (2000-01) for UMTS.

Alternatively, instead of being signaled by the Node B to the CRNC, this information can be communicated to the CRNC by some other means, in particular by the operation and maintenance (O&M) means of the system.

The CRNC takes account of the various limits which are signaled or communicated to it in this way by verifying, for each of the parameters taken into account, whether or not the limit has been reached. For example, if it receives the above-defined item N_{MAX}, D1_{MAX}, and D2_{MAX}, it verifies whether:

the number of radio links established in the cell or the Node B is less than N_{MAX};

the maximum net data rate in the up direction (in kbps) that the convolutional decoder of the Node B needs to process, given all of the radio links established in the cell or in the Node B is less than D1_{MAX}; and

the maximum net data rate in the up direction (in kbps) that the turbo-decoder of the Node B needs to process, given all of the radio links established in the cell or in the Node B, is less than D2_{MAX}.

If any one of these conditions is not satisfied, it can decide, for example, not to accept a new call in the cell or in the Node B under consideration.

For a Node B handling a plurality of cells (e.g. three), and for example in the case considered above where the signaling message sent from the Node B to the CRNC contains four different values for each criteria, one per cell and for the Node B, the CRNC verifies four constraints, one for all of the links in each cell and one for all of the links in all of the cells of the Node B.

1/ A method of taking account of traffic processing capacity for the purpose of traffic load control in a mobile radio network, wherein account is taken of one or more limits in said processing capacity corresponding to one or more parameters representative of said traffic load.

2/ A method according to claim 1, wherein one of said parameters is associated with the number of radio links that can be established, and a corresponding limit is represented by a maximum number of radio links that can be established.

3/ A method according to claim 2, wherein said maximum number of radio links is a maximum number of radio links that can be established in macrodiversity.

4/ A method according to claim 2, wherein said maximum number of radio links is a maximum number of radio links that can be established in transmission diversity.

5/ A method according to claim 2, wherein said maximum number of radio links is represented by a maximum number of radio resources that can be allocated.

6/ A method according to claim 1, wherein one of said parameters is associated with data rate for established radio links, and a corresponding limit is represented by a maximum data rate for the established radio links.

7/ A method according to claim 6, wherein said maximum data rate is a maximum data rate in the up direction.

8/ A method according to claim 6, wherein said maximum data rate is a maximum data rate in the down direction.

9/ A method according to claim 6, wherein said maximum data rate is a maximum data rate for a first type of traffic, for which a first type of error correcting code is used.

10/ A method according to claim 6, wherein said maximum data rate is a maximum data rate for a second type of traffic, for which a second type of error correcting code is used.

11/ A method according to claim 9, wherein a first type of error correcting code is a turbo-code.

12/ A method according to claim 10, wherein a second type of error correcting code is a convolutional code.

13/ A method according to claim 6, wherein said data rate is a net data rate.

14/ A method according to claim 1, wherein said limits are considered on a per cell or a per base station basis.

15/ A method according to claim 1, wherein said limits are considered per physical channel.

16/ A method according to claim 1, wherein said limits are considered per type of physical channel.

17/ A method according to claim 16, wherein one type of physical channel is a dedicated physical channel.

18/ A method according to claim 16, wherein one type of physical channel is a common physical channel.

19/ A mobile radio network, including means for implementing a method according to claim 1.

20/ A base station for a mobile radio network, the station including means for implementing a method according to claim 1.

21/ A base station according to claim 20, wherein said means comprise means for signaling one or more limits in its processing capacity to a base station controller that controls it, said limits corresponding to one or more parameters representative of traffic load.

22/ A base station controller for a mobile radio network, the controller including means for implementing a method according to claim 1.

23/ A base station controller according to claim 22, wherein said means include means for verifying whether one or more limits in the processing capacity of a base station under its control and corresponding to one or more parameters representative of traffic load has been reached.
